(19) United States
(12) Patent Application Publication
(10) Pub. No.: US 2002/0062573 A1
(43) Pub. Date: May 30, 2002

(54) Digital micrometer head and caliper connected with computer

(76) Inventor: Shawky Z. Nada, Jersey City, NJ (US)

Correspondence Address: SHAWKY Z. NADA, Suite 331, 845 BERGEN AVE P.M.B, JERSEY CITY, NJ, 07306, US

(21) Appl. No.: 09/791,466

(22) Filed: May 29, 2001

Related U.S. Application Data
(60) Provisional application No. 60/186,087, filed on Feb. 28, 2000.

(51) Int. Cl. G01B 5/00

(52) U.S. Cl. 33/784

(57) ABSTRACT

The Using the relation ship between the change of distance and resistance in measuring the distance as function of the resistance.(two design of digital caliper and one design of digital micrometer head)

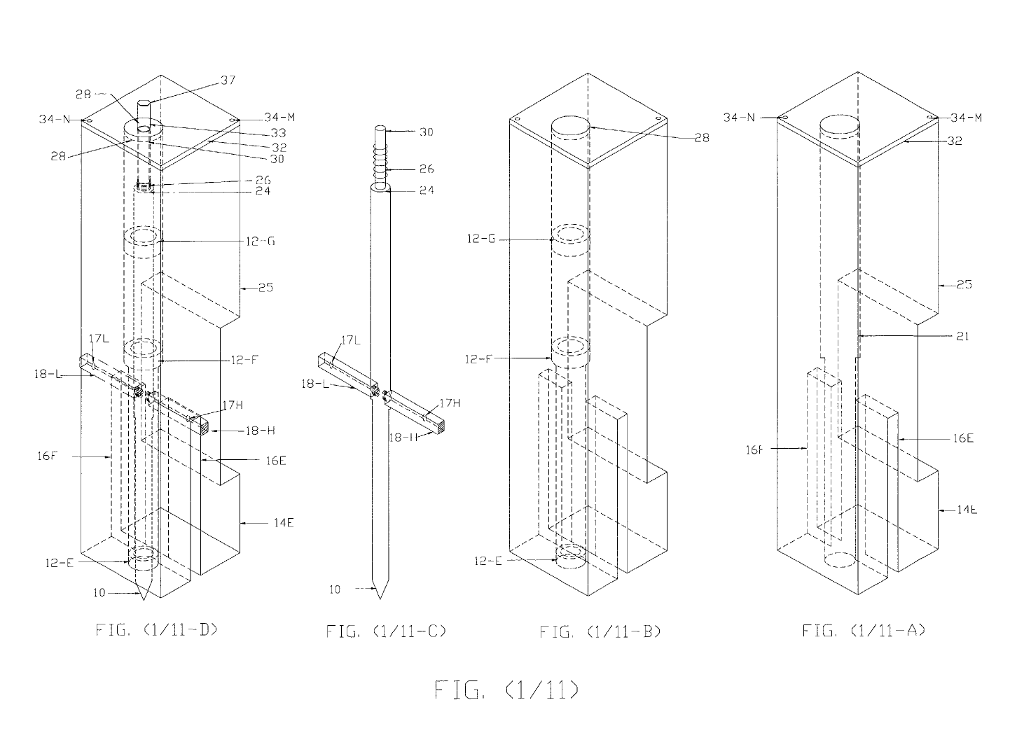

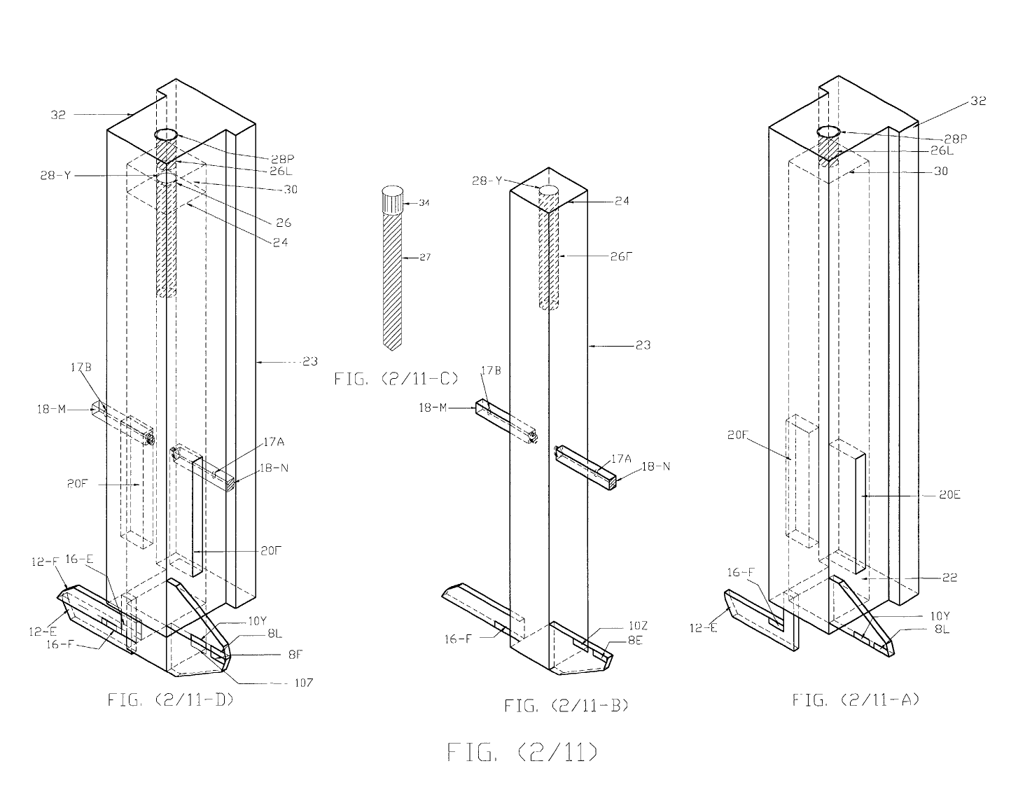

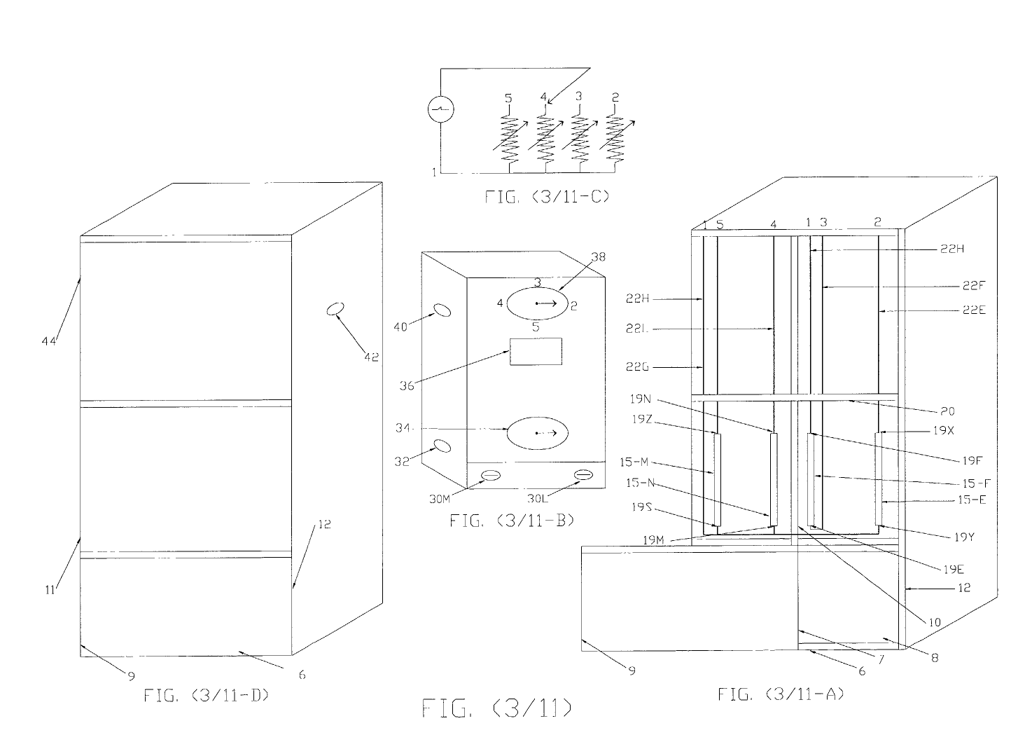

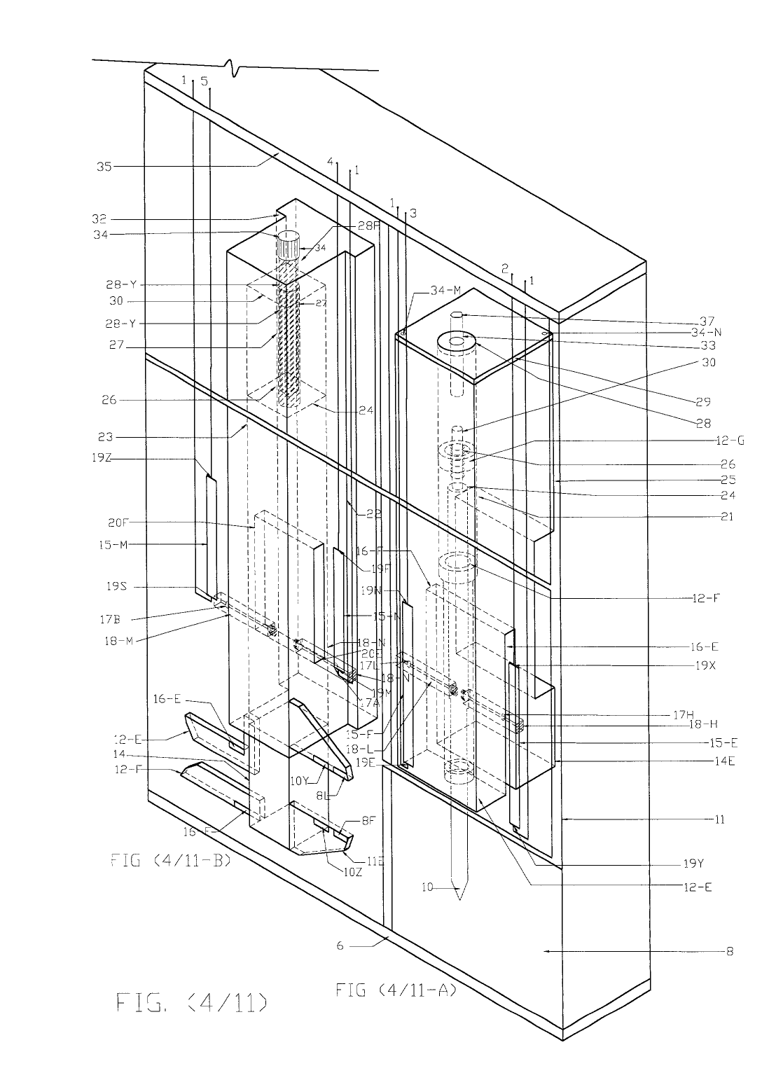

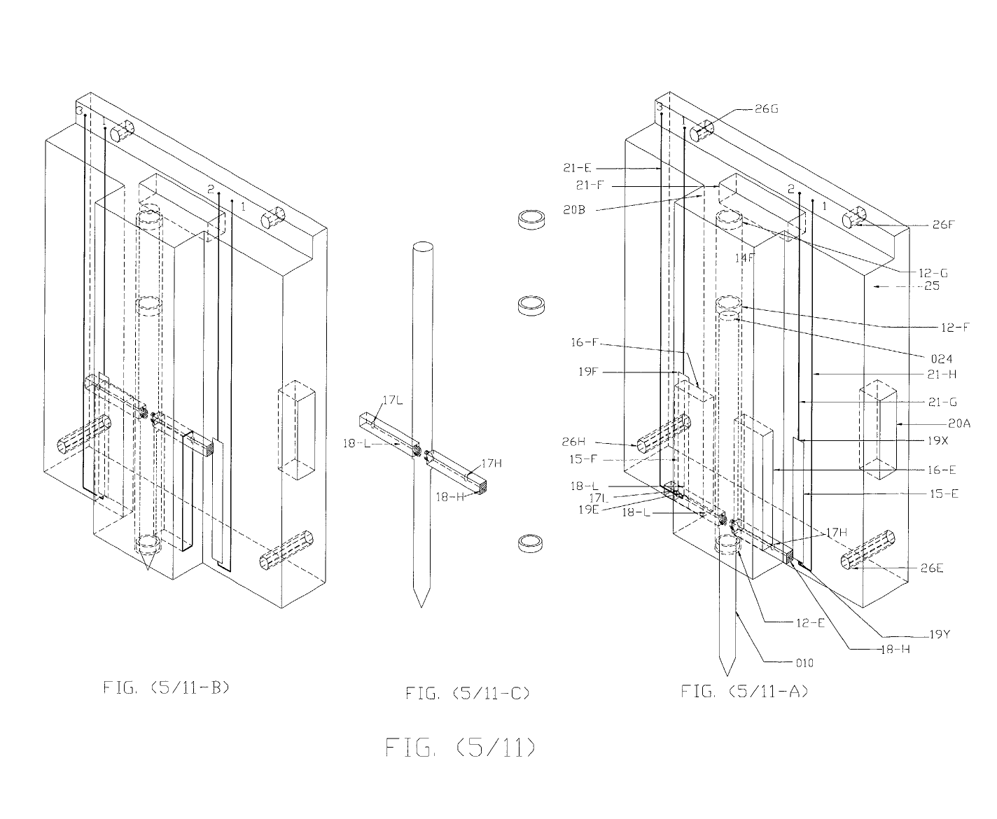

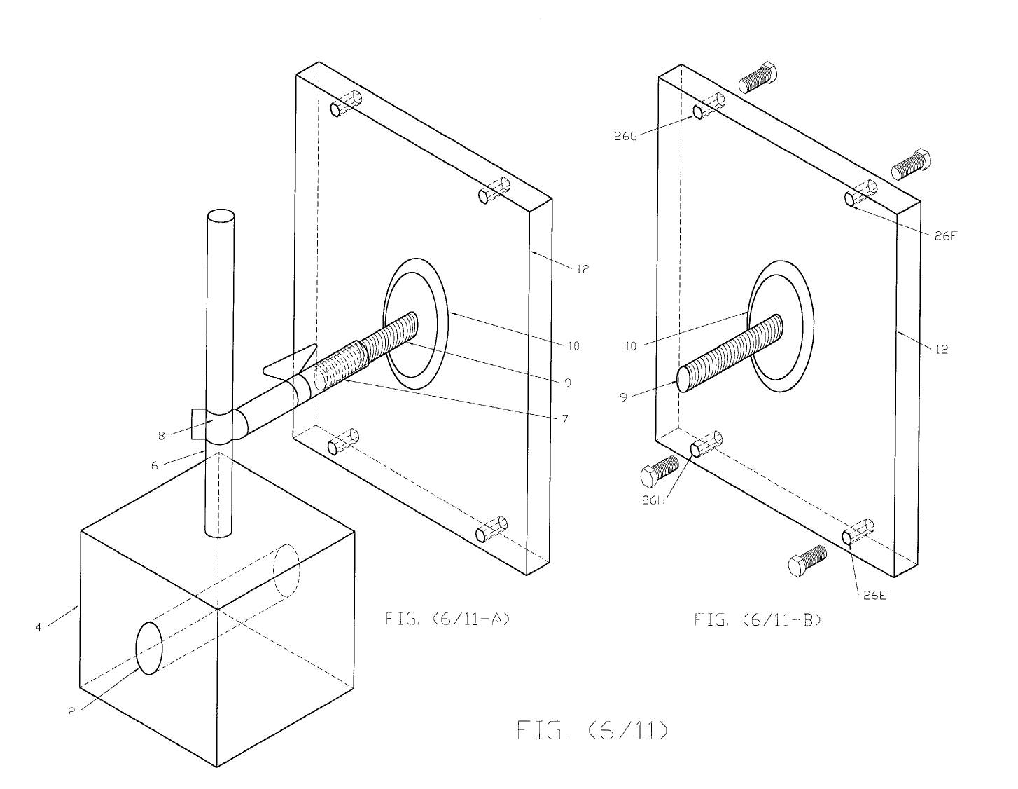

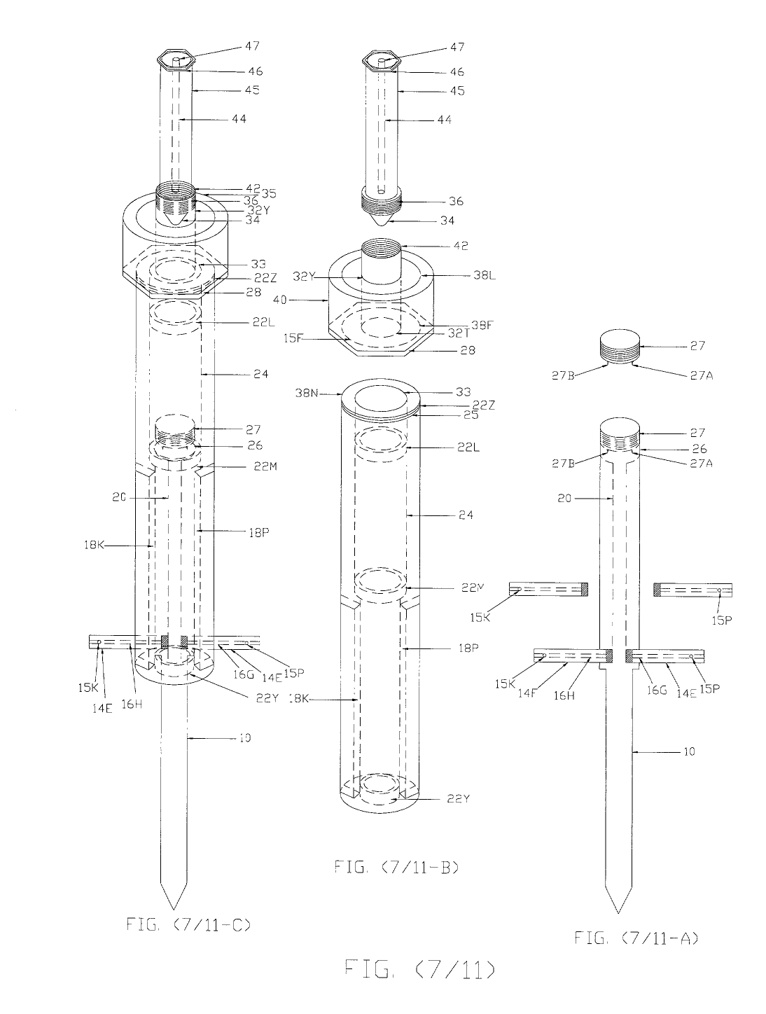

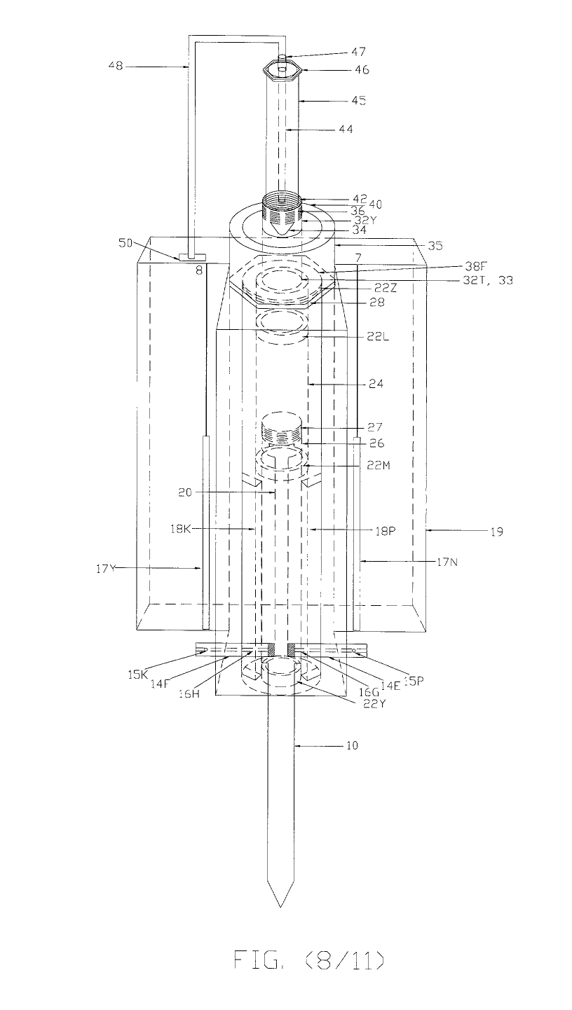

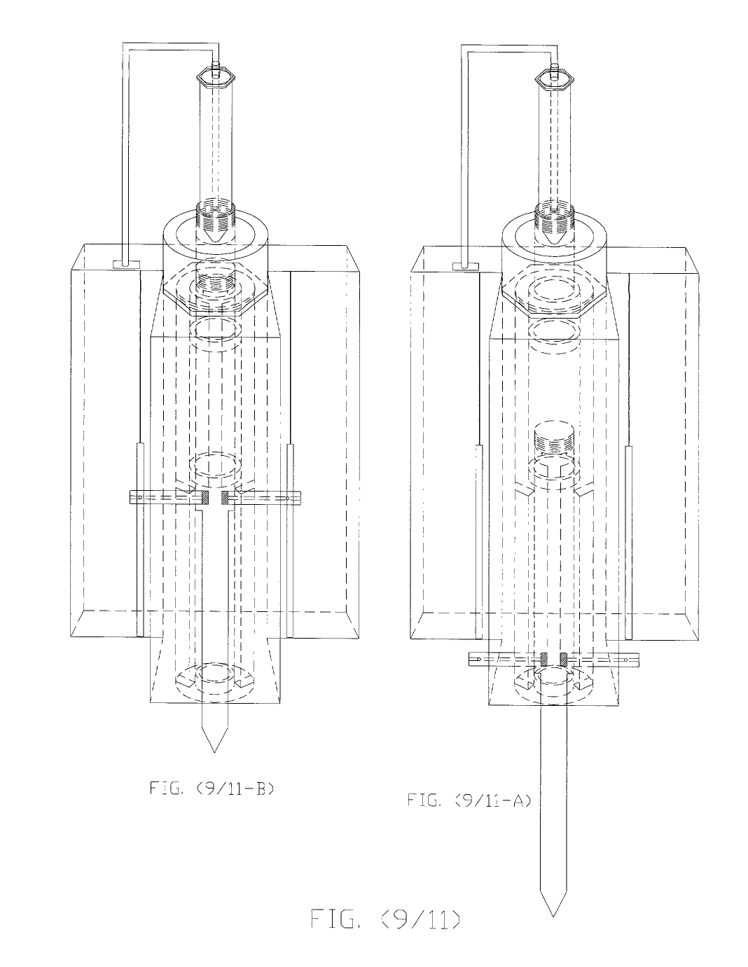

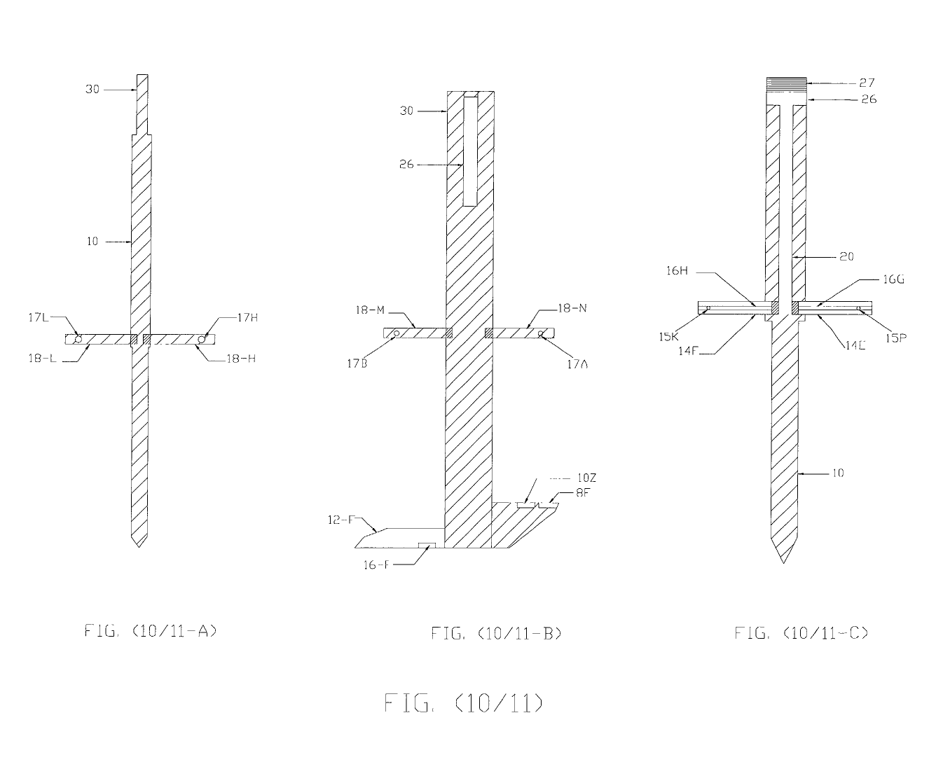

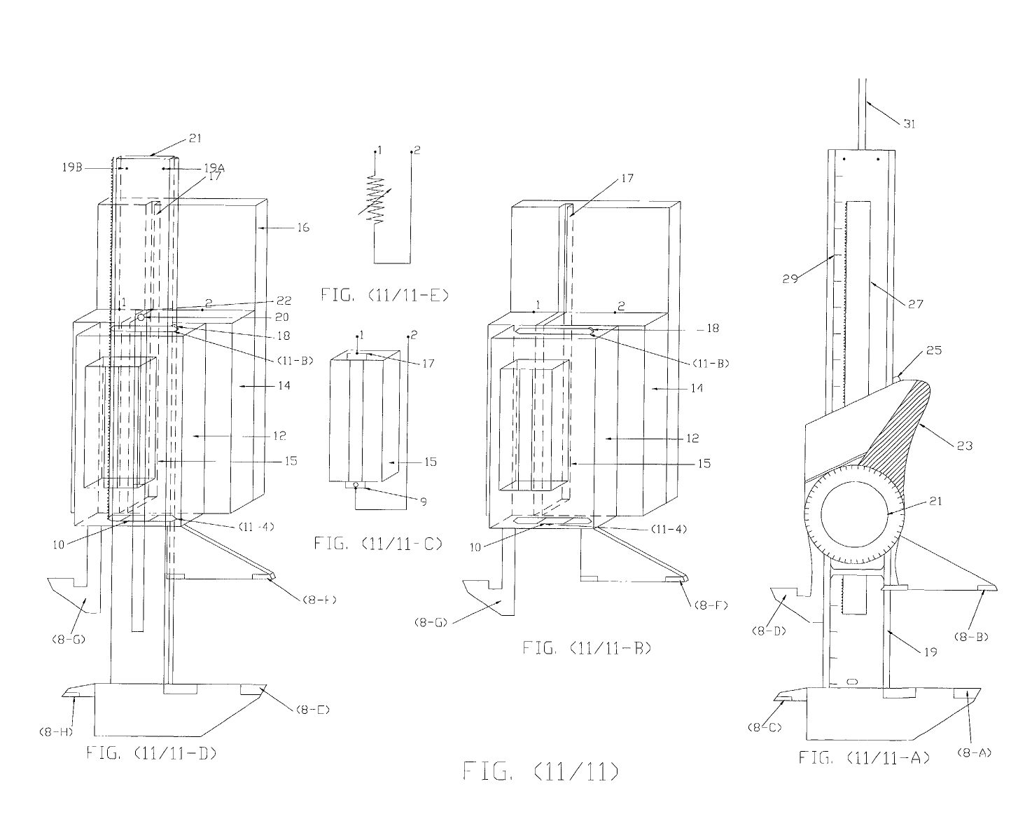

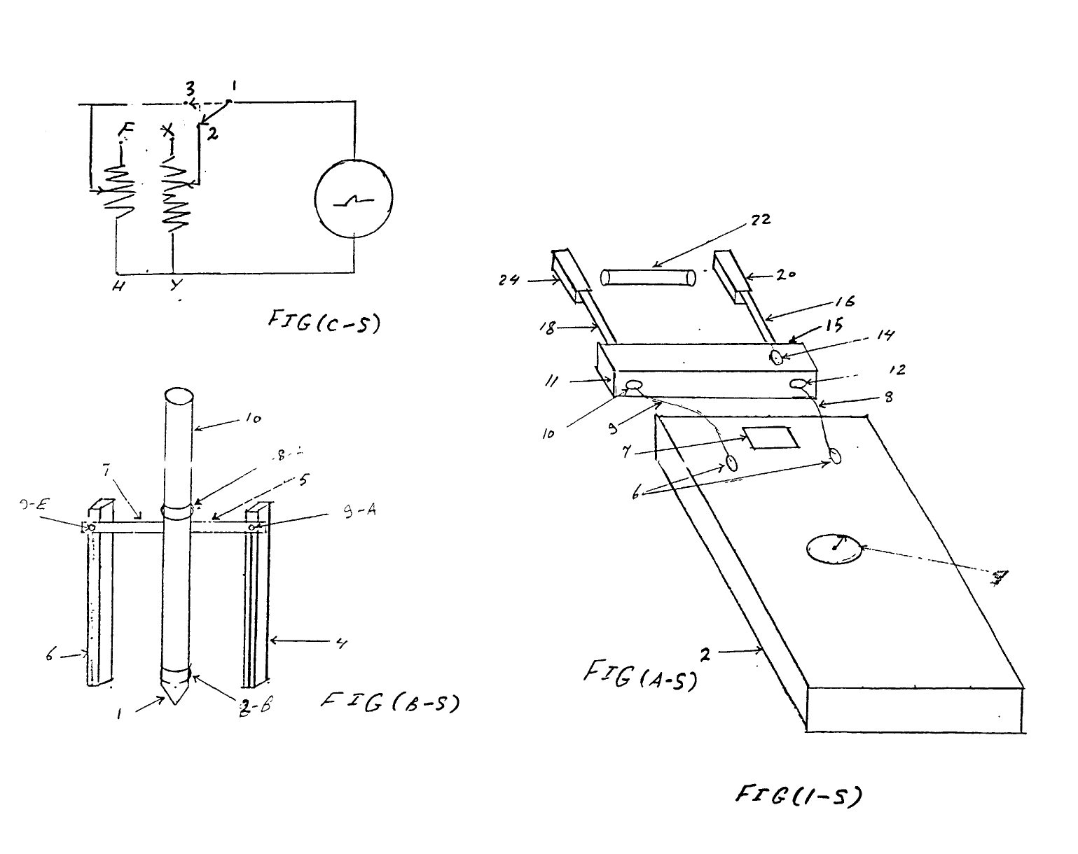

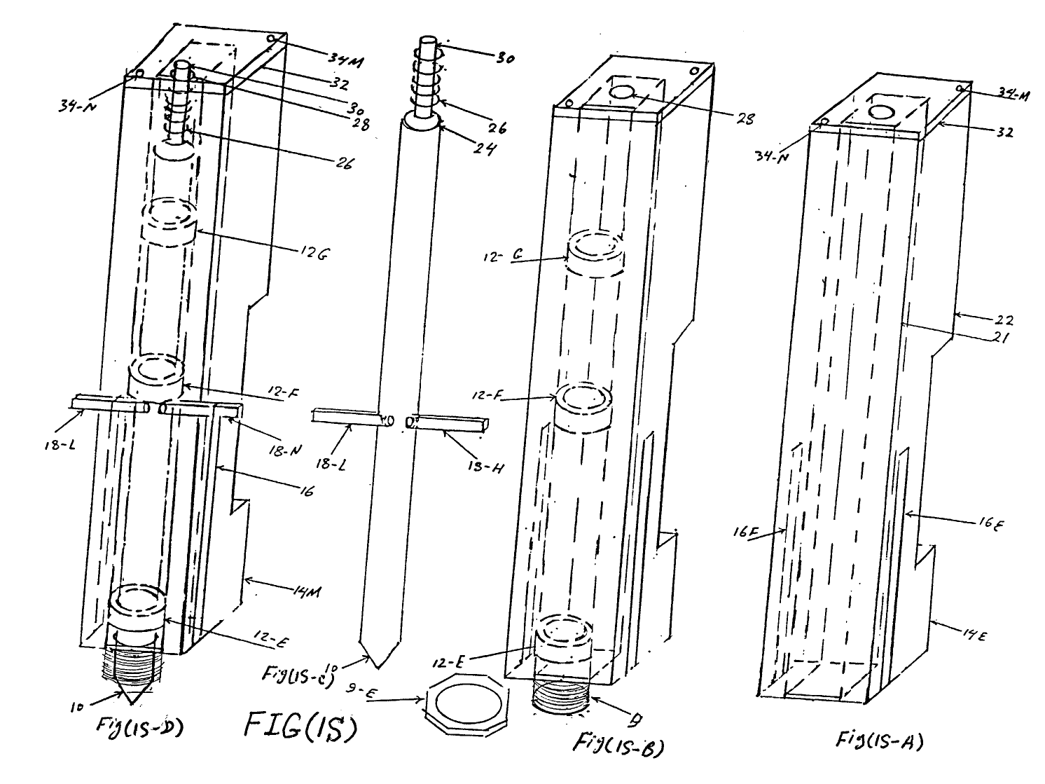

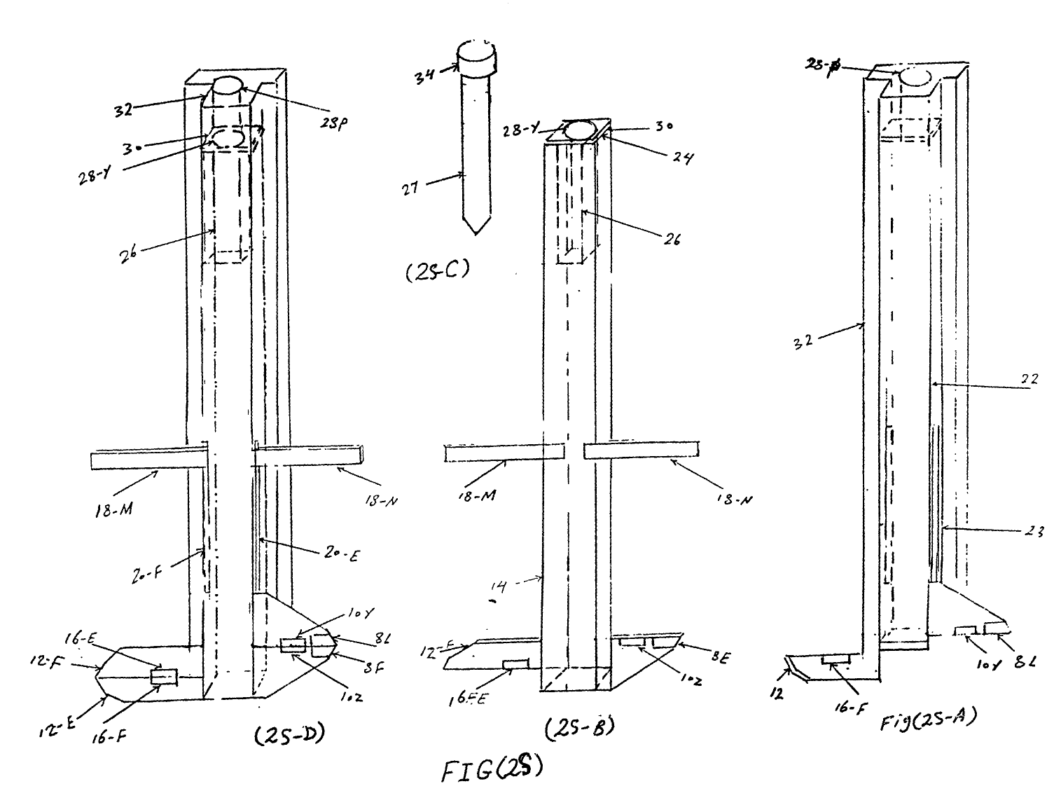

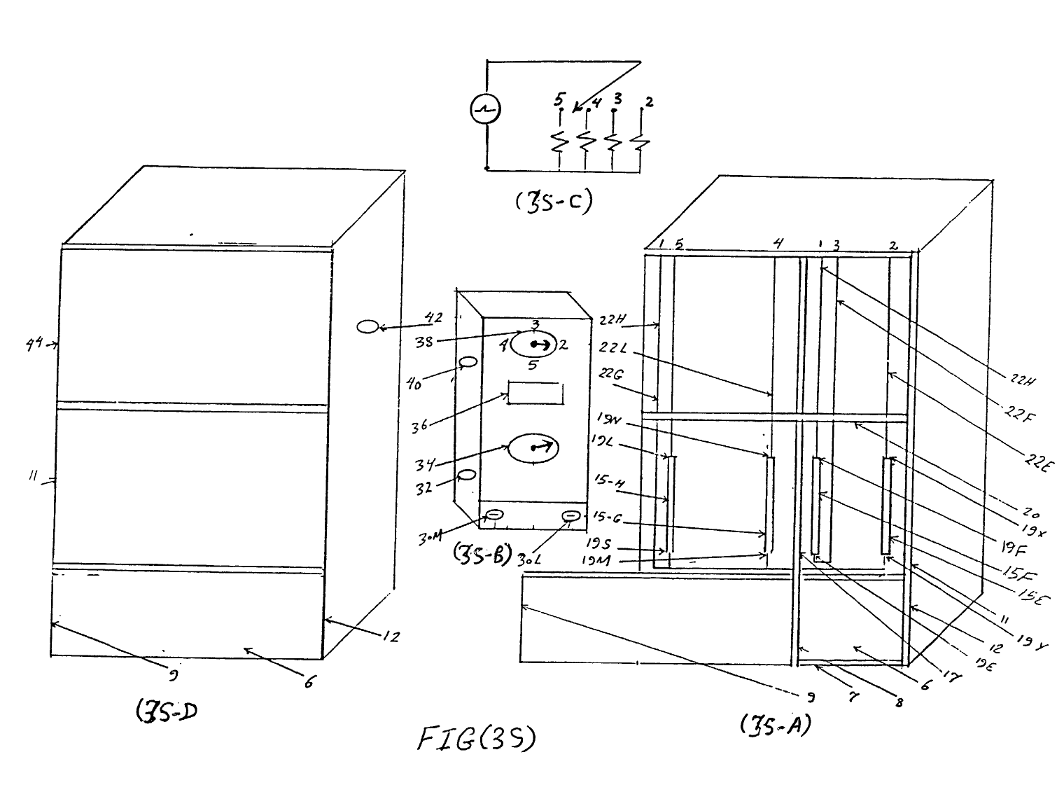

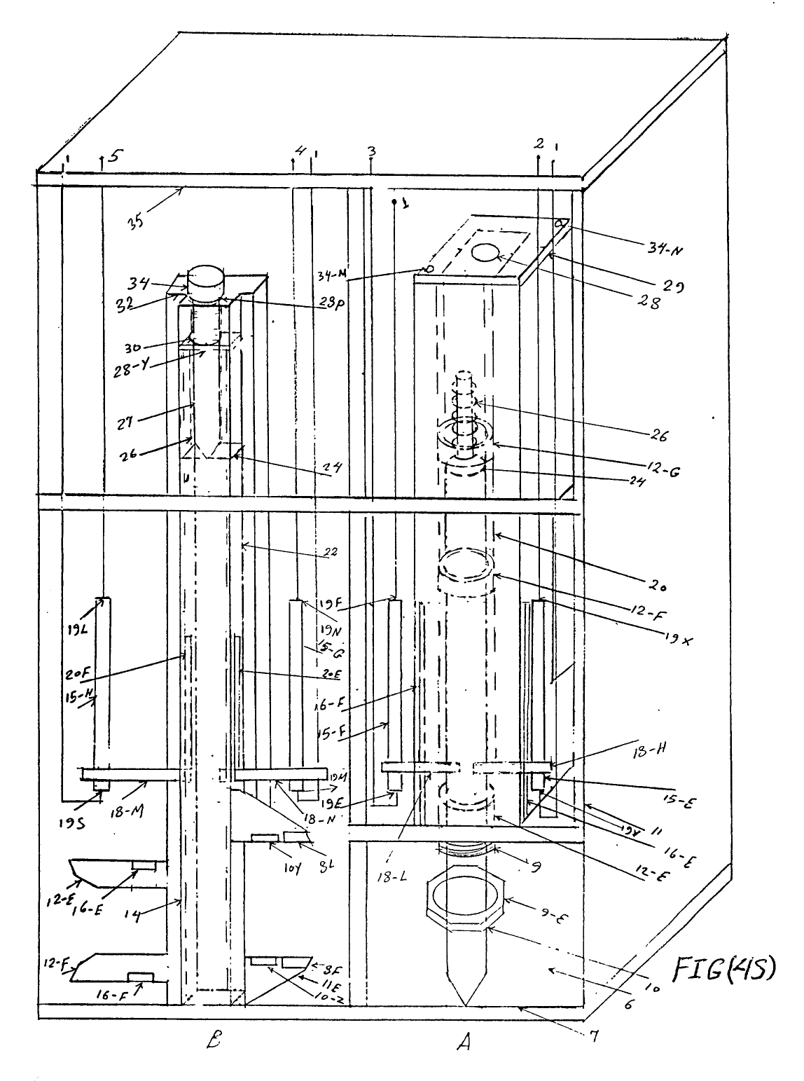

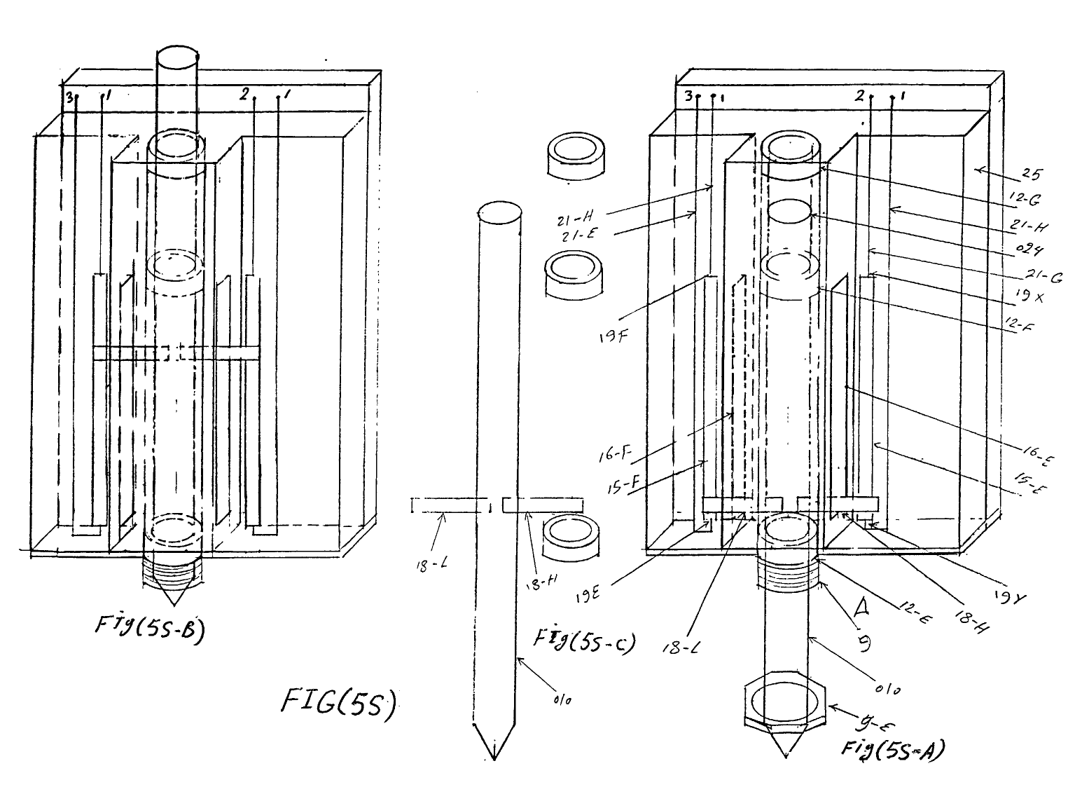

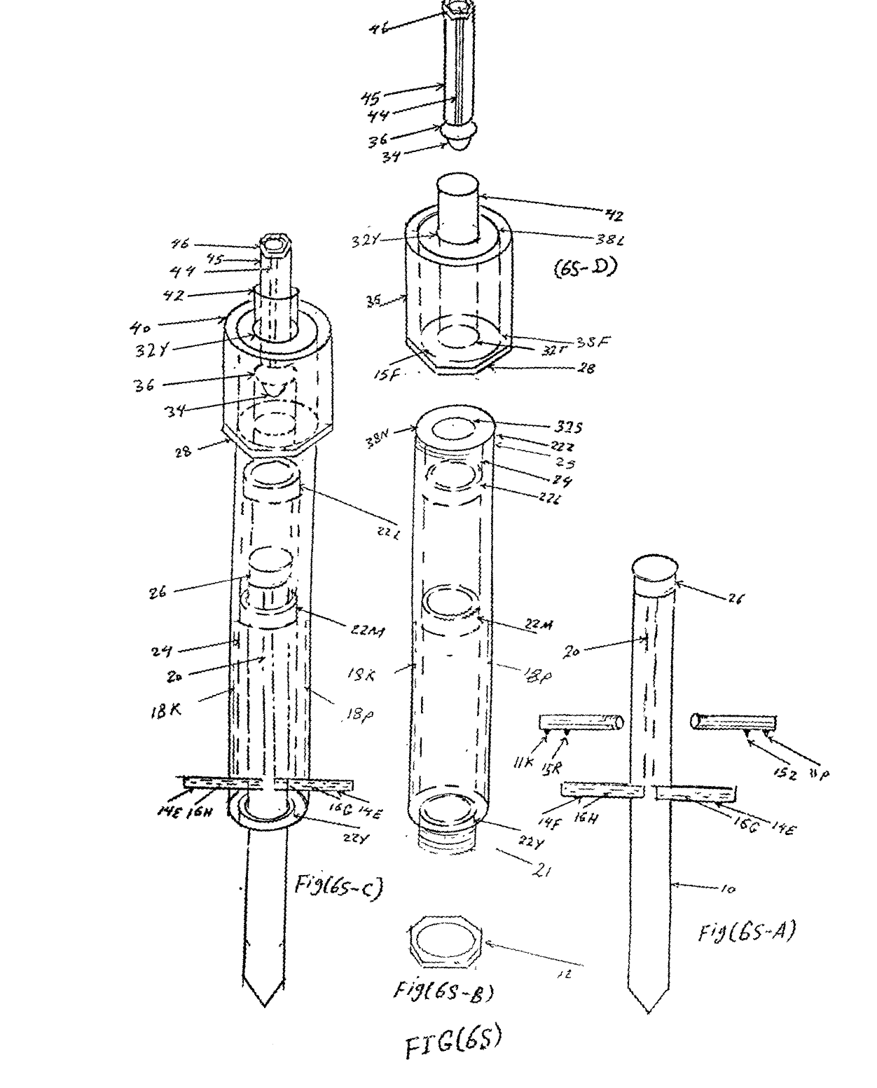

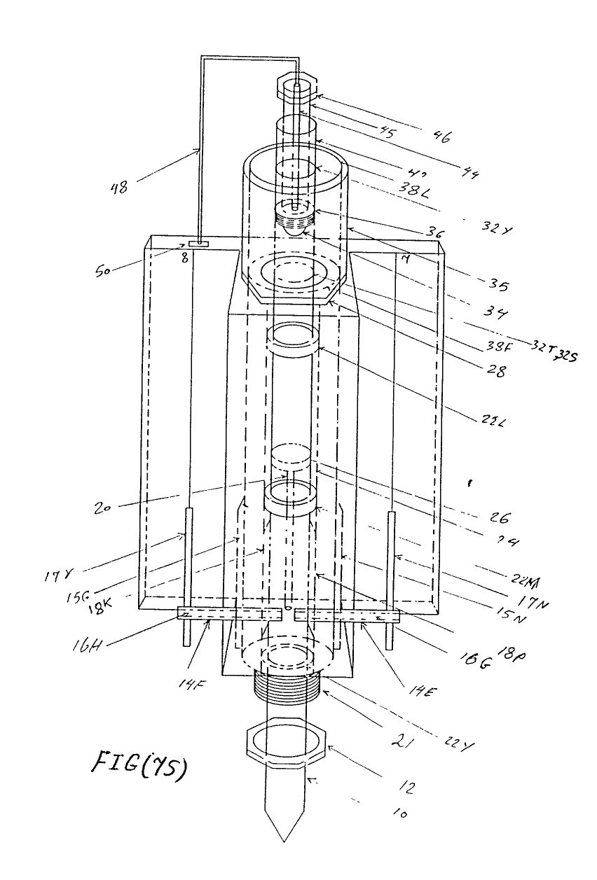

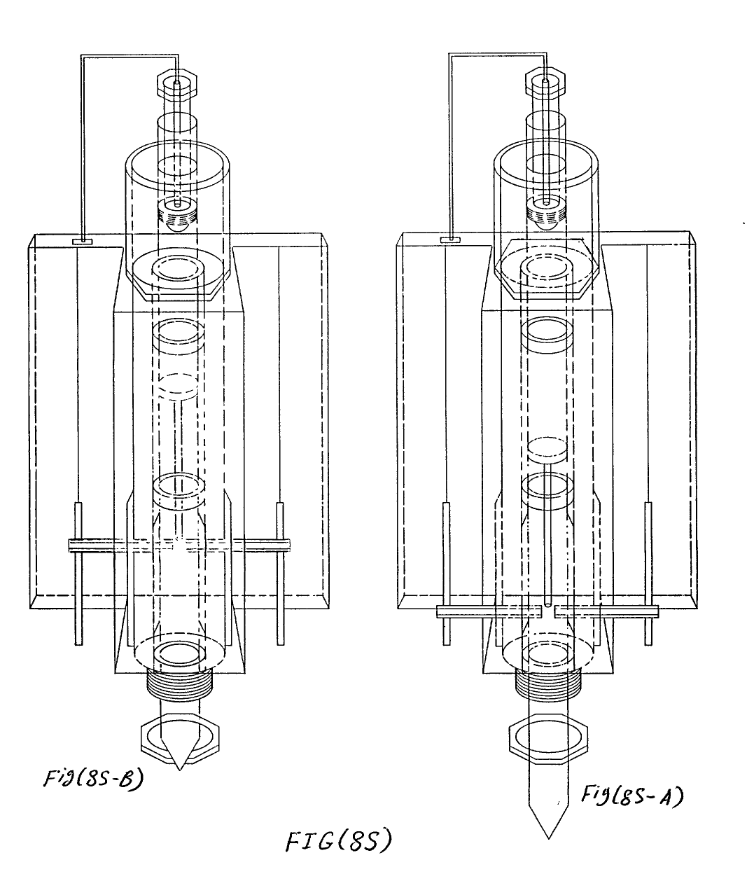

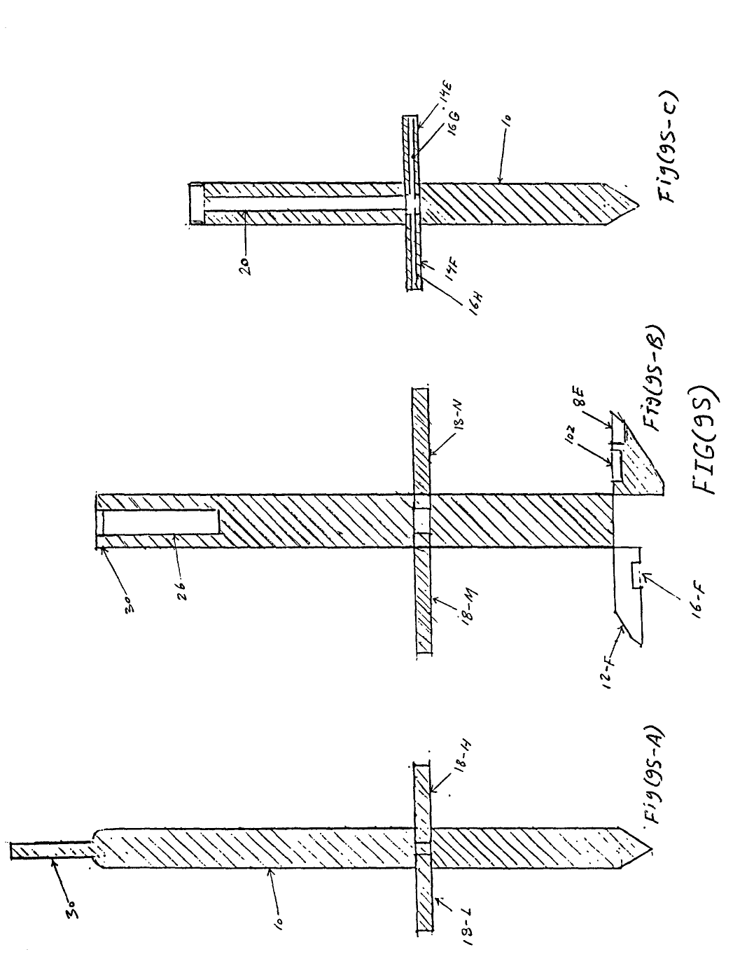

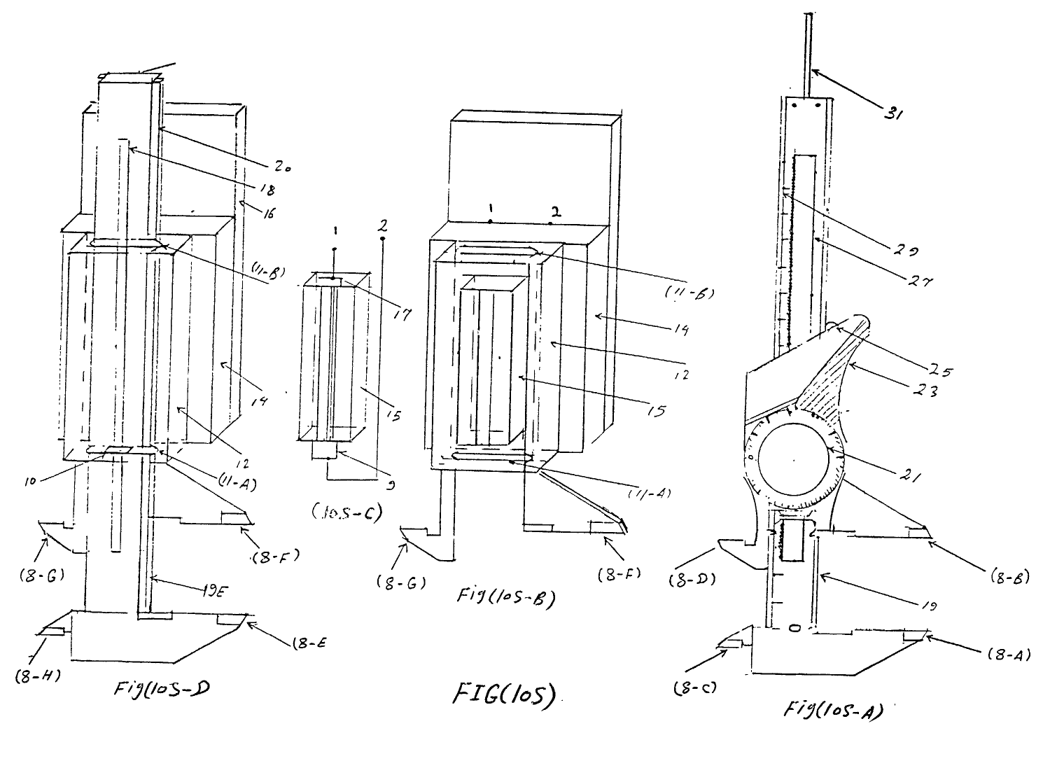

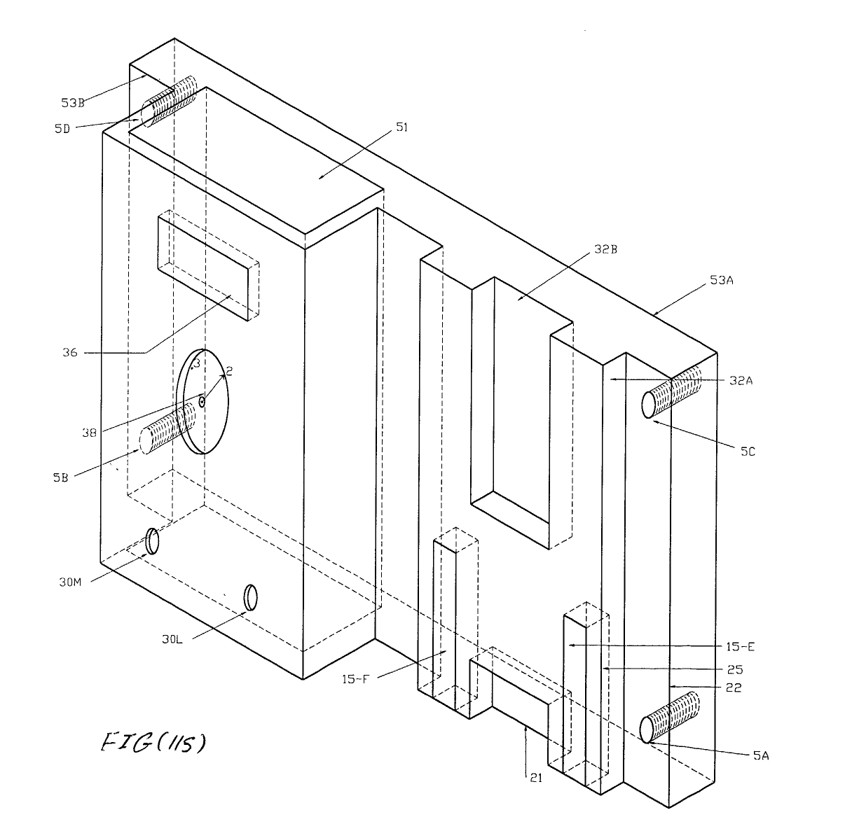

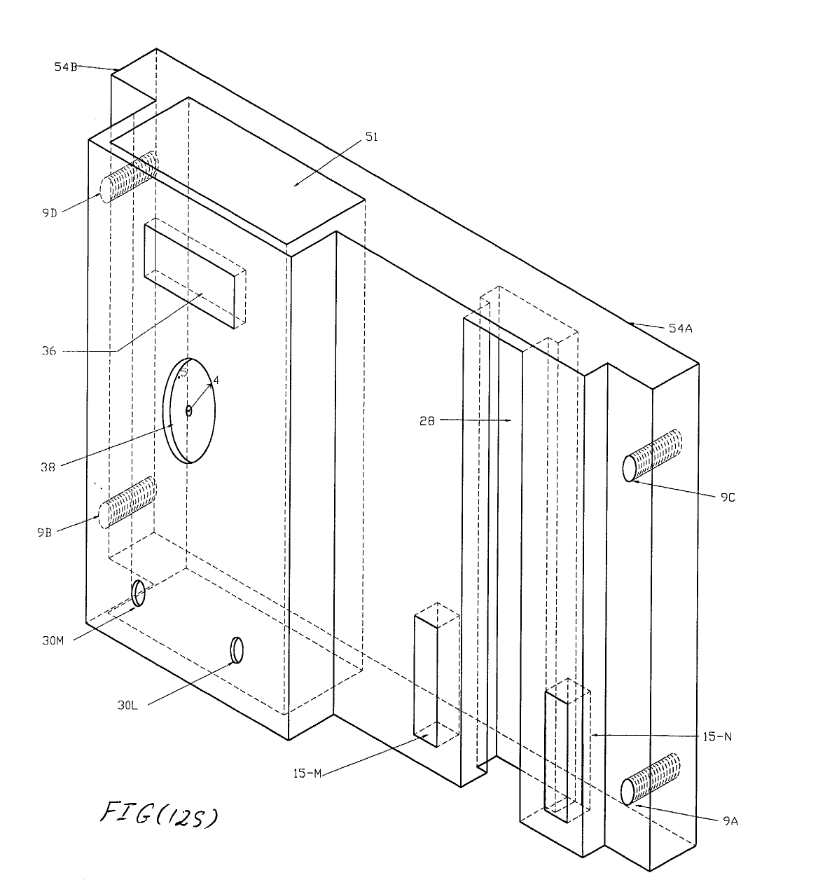

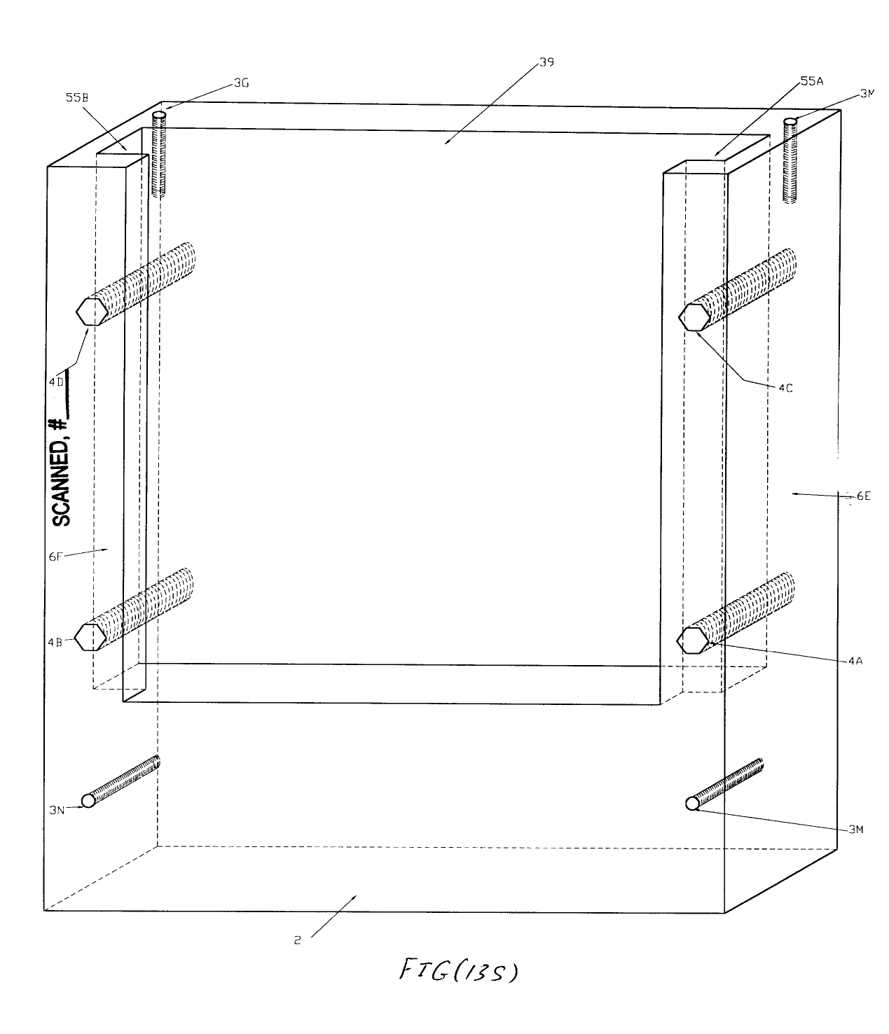

Measuring the distance by knowing the change in the resistance of the photoelectric cell as a result ofplacing the cell close or far from the light source (one design of digital micrometer head)

First Concept

measuring the distance as a function of the change in resistance:

Is utilized in design of the Caliper ,FIG.(4/11-B), FIG. (11/11-D) and Digital micrometer Head, FIG. (5/11-A),FIG. (4/11-A).

The concept is generally built on the following:

1- Using of a shaft with two arms fixed on it, that shaft can move up and dawn.

2- the two arms are connected to two arms of potentiometer(variable resistors),the resistance can be changed by moving the two arms which move with the shaft since they are connected to it.

3- When the shaft is moved up, then the two arms of the movable shaft change the resistance in a value that is proportional to the moving distance.

4- the two potentiometer are fixed opposite to each other.

The resistance increase in the potentiometer when it moves from dawn up (used in the upward motion), while the second potentiometer scale goes from up downward(used in the downward motion).

The shaft is free to move in all positions, its bottom lower end conical shape

If I make the height and the diameter of the conical shape are equal, I can use this conical for measure small diameters (reading of height are equal diameter which the conical move inside the cylinder) used the second variable resistance.

5- In case of using the Caliper, the shaft is not free to move, instead a screw is used to control its motion.

The screw is on the top of the shaft and goes inside it to enable the manual control of motion, it's clear at FIG. (2/11-D).

### BACKGROUND

1. Field of the Apparatus

The caliper is used for measure the thickness, inside outside diameter by digital. the digital micrometer used as( dial inductor), for measure sinking of pillars at case of cracking in horizontal and vertical beam. accuracy of the instrument is disclosed the instrument design is distinctive.

It is connected with computer.

It's(LCD resolution) is 0,0000001 millimeter.

### OBJECT AND ADVANTAGE

1-The apparatus connected with computer.

2-the apparatus is used to measure the effect of pressure of load on sample of dust on length at test of land before high building construction.

3- It used for measure the thickness length, and inside out side diameter.

4- It used for measure samples which are move or still.

5-I can have reading every instant if sample increase or decrease.

6-the apparatus is cheap and have (LCD resolution) 0,000001.

7-It develop with develop of the malt meter.

8- The apparatus used as digital micrometer head.

9-I can have the velocity of decrease or increase of the length of samples ( by find the relation between length and time).

10-The instrument is used for measure the sinking of pillars at cause of cracking in horizontal and vertical beams.

### DRAWING FIGURES

FIG.(1/11)

It represent FIG. (1/11-A),FIG. (1/11-B),FIG. (1/11-C), and FIG. (1/11-D). FIG. (1/11-D) represented FIG. (1/11-A),FIG. (1/11-B),and FIG. (1/11-C) after gather the parts. FIG. (4/11-A) represent FIG. (1/11-D) at final fixed.

FIG (2/11)

It represent by FIGS. (2/11-A),(2/11-B),(2/11-C) and (2/11-D).

FIG. (2/11-D) represented FIG. (2/11-A), (2/11-B), and (2/11-C) after gather the parts.

FIG. (4/11-B) represent FIG. (2/11-D) at final fixed.

FIG (3/11)

It represent FIG. (3/11-A), (3/11-B), (3/11-C) and FIG. (3/11-D). FIG. (3/11-C) represent the electric circuit of connection of the variable resistance.

FIG(4/11)

It represents by FIG. (4/11-A), FIG. (4/11-B),as caliper, and micrometer head as one instrument.

FIG. (4/11-A) represent FIG. (1/11-D) after fixed the variable resistance

FIG. (4/11-B) represent FIG. (2/11-D) after fixed the screw which control of moving.

FIG.(5/11)

It is another design of micrometer head at FIG. (1/11-D). this design hung and use like dial indictor.

FIG. (6/11)

It represent by FIG. (6/11-B) which fixed FIG. (5/11-A)by (4) screw and hung it FIG. (6/11-A)

FIG.(7/11)

It represent by FIG. (7/11-A), (7/11-B), (7/11-C). FIG. (7/11-C) represent FIG. (7/11-A), FIG. (7/11-B) after fixed it.

FIG. (8/11)

Represent FIG. (7/11-C) at final fixed at the frame and fixed the slide of printed cupper (17N), and (17Y).

FIG.(9/11)

It represent FIG. (8/11) when conical shaft move to up level, and lower level. when conical shaft moves to dawn level by FIG. (9/11-A) and to up level by FIG. (9/11-B).

FIG.(10/11)

It's a cross section at conical shaft at FIG. (1/11-C), FIG. (2/11-B), and FIG. (6/11-A) continuous.

It represent by FIG. (10/11-A), (9/11-B), (9/11-C) continuous. FIG.(11/11)

It represented by FIG. (11/1-A),FIG. (11/11-B),FIG. (11/11-C), FIG. (11/11-D), FIG. (11/11-E)

FIG. (11/11-A) represent ideal caliper, and FIG. (11/11-B) represent fixed part of the new caliper

FIG. (11/11-C),and FIG. (11/11-E) represent variable resistance and it's electrical circuit.

FIG. (l1/11-D) represent new design FIG. after change the fixed part(23)at FIG. (11/11-A)by the frame at FIG. (11/11-B) which contain the variable resistance at FIG. (11/11-C)

### DESCRIBE DRAWING FIGURES

1-DIGITAL MICROMETER HEAD

I used the relation between the change of variable resistance and distance. It represented by FIG. (1/11) and FIG. (4/11-A). FIG. (5/11)represent another design of digital micrometer can be hung.

2-DIGITAL MICROMETER HEAD (BY USING SOLAR CELL)

I used the relation between the change of the resistance of solar cell and distance of light or strength of light it represent by FIG. (7/11). FIG. (8/11), FIG. (9/11)

3- DIGITAL CALIPER

I used the relation between the change of the variable resistance and distance. It represented by FIG. (2/11),FIG. (4/11-B). FIG. (3/11) represent how can fixed digital micrometer head, and digital caliper together. and electrical circuit diagram.

4-ANOTHER DESIGN OF DIGITAL CALIPER

FIG. (11/11) represent another design of digital caliper.

In this design I changed the ideal caliper to digital caliper.

5-LENGTH CROSS SECTION OF THE MOVABLE SHAFT AT THE THREE INSTRUMENT

It represented by FIG. (10/11)

### SUMMARY OF DESCRIBE THE DRAWING FIGURE

1- FIG. (1/11) represent mechanical part of the digital micrometer head before connected the variable resistance..

2- FIG. (2/11) represent mechanical part of the digital caliper before connected the variable resistance, and the screw at FIG. (2/11-C).

3-FIG. (3/11) represent how I connected the variable resistance at digital caliper and digital micrometer head and connected them with malt meter.

4-FIG. er (4/11) represent the digital caliper, and digital micrometer head fixed together at fmal which the variable resistance are fixed and I used one malt meter, itfs clear at FIG. (3/11).

5-FIG. (5/11) represent another design of digital micrometer head can hung it like dial indicator.

6-FIG. (6/11) it represent how can hung digital micrometer like dial indictor.

7-FIG. (7/11).FIG. (8/11). and FIG. (9/11) represent digital micrometer head by using solarcell

7- FIG. (l0/11) represent length cross section of the three movable shaft at FIG. (1/11-C), FIG. (2/11-B), and FIG. (6/11-A).

FIG (1/11)

I describe FIG. (1/11-D) because it represent FIG. (1/11-A), (1/11-B),(1/11-C) after gather it. (10) cylindrical movable of conical shape.

(12-E),(12-F),(12-G) are three belt bearing or small cylinder.

(14E) back adage of the frame.

(16E,16F) are two longitudinal opening.

(17-L),(17-H) are two arms of the variable resistance.

(18-H), (18-L) are two arms fixed in the cylindrical movable shaft.

(24) the diameter of the movable shaft is change to smaller.

(25) the back adage of the frame at the top.

(26) spiral wire.

(30) small diameter of the movable shaft.

(33) small cylinder fixed at the cover over the spiral wire to posh movable shaft dawn,

This small cylinder have screw out side to control for moving up and dawn.

(34-M).(34-N) are two screw for fixed the cover.

(37) the top of cylinder (33) as hexagonal.

FIG.(2/11)

I describe FIG. (2-D) because it represent FIG. (2/11-A), FIG. (2/11-B) but screw at FIG. (2/11-C) not fixed at FIG. (2/11-D)at screw cylinder (26).

(8F.8L) edges of the two ends of the apparatus at the right side.

(10Z,10Y) are the two right lower ends of the moving part and fixed part of the caliper.

(16-E),(16-F) two engraved parts by slop at left side.

(17A,17B) are two arms of the variable resistance(15-E),(15-F) fixed at the two arms of

the movable shaft it's clear at FIG. (4/11-A).

(18-M),(18-N) are two arms fixed by screw in the movable shaft.

(20E,20F) longitudinal opening for move the arm of the movable shaft.

(23) moving column.

(24L) top of moving column, after this point it's diameter become smaller.

(26) cylindrical opening the screw moving inside it at fixed part.

(26F) cylindrical screw from inside in the movable column.

(28P) the top of the cylindrical at fixed part.

(28-Y) the top of cylinder at movable column.

(30) higher level that movable can reach.

(32) the top end of the frame as (L) shape.FIG(2/11-C) represent screw (27) it's nail head (34),it's fixed inside (26L) and throw (26) to control the moving of the movable column

FIG. (3/11)

It represented by FIG. (3/11-A).(3/11-B),(3/11-C),(3/11-D).

FIG. (3/11-A)

(2,3,4,5) are connection point between the terminal resistance and malt meter.

(1) is sharing point as second terminal between the all terminal variable resistance and the malt meter.

(6) bottom plane of dawn box represent zero level.

(7,9) start and the ending of cover of the dawn box, this cover can open to left side.

(8) empty space at dawn part of box to can move the movable shaft dawn.

(10) deviation part between the two instrument.

(15E,15F) the two variable resistances at digital micrometer head at right side.

(15-H), (15-G) the two variable resistance of the caliper at left side.

(19x,19Y) the connection terminals of variable resistance (15E).

(19-F),(19-E) the connection terminal of the variable resistance (15F).

(20) road welding between the two parts of edge of the box..

(22E,22F,22L,22G,22H) connection of line of cupper printed on isolated viper ( as used at electronic circuit of radio and TV)between (2,3,4,5)and the variable resistance, point.

(1)is the second point sharing between all resistance it is line cupper represented by(22H).

FIG. (3/11-B)

It represent digital malt meter or ohmmeter.

(32) open hole to connection to computer.

(34) indictor of malt meter at ohm range.

(36) digital screen for reading.

(38) indictor to control the change between the sharing point (1)and the terminal point.

(2,3,4,5) of the four variable resistance at FIG. (3/11-A).

(40) open hole to connection between the malt meter and the apparatus at FIG. (3/11-A).

FIG. (3/11-C)

It represent the electric circuit of the apparatus.

(1) is sharing point.

(2,3) represent the variable resistance (15E,15F) at digital micrometer head at FIG. (3-A).

(4,5) represent the variable resistance (15-H),(15-G) at caliper at FIG. (3-A).

FIG. (3/11-D)

It represent the box which contain digital micrometer head, and caliper.

(6) is the zero level.

(9,11,44) three covers can open.

(12) the edge of the box.

(42) hole to connection between the apparatus and the malt meter for reading.

FIG.(4/11)

It represent the instrument after fixed FIG. (1/l)at right side and fixed FIG. (2/11) at left side inside FIG. (3/11).

Then I have new figure FIG. (4/11-A), (4/11-B). FIG. (4/11-A)

I used with FIG. (1/11) at right side two variable resistance (15-E), (15-F).

The variable resistance (15-E) it's terminal (19X)at up side the start of reading and (19Y) at dawn side the end of reading.

Terminal(19X) connected to point(2),and terminal (19Y) to point (1) sharing point The other variable is(15-F) it's terminal (19F)at up side the end of reading and (19Y) at dawn side the start of reading.

Terminal (19F) is connected to point (3), and terminal (19Y) to point (1) sharing point. All connection of the terminals of the variable resistance by printed cupper wires. We control for change of resistance by the arms (17H, 17L), I fixed them at the two arms of the movable shaft

(8) Empty space to move the movable shaft.

FIG. (4/11-B)

I used with FIG. (2) left side two variable resistance (15-M), (15-N). The variable resistance (15-N) it's terminal (19N) at up side the start of scale reading and (19M) at dawn side the end of scale reading. Terminal (19N) connected to point (4), terminal (19M) to point (1) sharing point This connection by printed cupper wires. The other variable resistance (15-M) it's up terminal (19Z) the end of scale reading and dawn terminal (19S) the start of scale reading.

Terminal(19Z) connected to point (5), terminal (19S) to point(1) sharing point. All this connection by printed cupper wires. All points (2,3,4,5) connected to indictor (38) at FIG. (3/11-B). It's more clear at FIG.(3/11).

At FIG. (4/11-B) I fixed screw (27) for control to move the column by move the head (34).

FIG (5/11)

It represented another design of digital micrometer head can hung as dial indictor by fixed it by four screw at frame can hung it, I fixed two (level of water) one vertical and other plane (20A,20B)

It represented by FIGS. (5/11-A),(5/11-B), (5/11-C).

FIG. (5/11-A)

It represent the apparatus when movable shaft at dawn position

(010) is movable shaft.

(12-E),(12-F),(12-G) ball bearing or little small cylinder

(15-E), (15-F) are variable resistance.

(16-E), (16-F) are longitudinal opining hole the two arms of the movable shaft move throw it.

(17L,17H) two arms of the variable resistance are fixed at the arms of the movable shaft.

(18-L),(18-H) two arms fixed at the movable shaft.

(19X,19Y) connection terminal of the variable resistance (15-E).

(19E,19F)connection terminal of variable resistance (15-F).

(20A,20B) two water level, one at vertical position, and the other at plane position.

(21-H),(21-G), (21-F),(21-E) are cupper printed to connected between the terminal of the variable resistance and points (1,2,1,3), this points are connected to malt meter.

The two variable resistance (15-E), (15-F) are sharing at point (1).

(25) It represent (L) shape of the frame at the top.

(26E,26H,26F,26G) are four hole to fixed the apparatus at frame.

FIG. (5/11-B)

It represent the apparatus at top position.

FIG. (5/11-C)

It represent the movable shaft (010), it have two arms (18-L),(18-H).

Arm(18-L) have the arm (17H) of variable resistance (15-E).

Arm(18-H) have the arm (17L) of variable resistance (15-F).

FIG. (.6/11)

It represented by FIG. (6/11-A) and FIG. (6/11-B)

FIG. (6/11-A)

It represented by a hung which fixed the micrometer head at FIG., (5/11) by four screw

(2) hole

(4) cubic as base

(6) cylinder shaft for move the frame at FIG. (6/11-B) up and dawn

(7) screw cylinder from inside

(8) screw cylinder from inside and I fixed inside it a screw shaft is fixed by angle, this shift have screw at out side

(9) cylinder has screw out side

(10)arise cylinder around shaft (9)

(12) frame have four screw to fixed the digital micrometer by four screw. FIG. (6/11-B)

It represented the frame which fixed the digital micrometer head by four screw inside holes (26E,26F,26G,26H)by nut and make the hole screw from inside

FIG (7/11)

IN THIS FIG. I USE THE IDEA OF THE CHANGE OF THE RESISTANCE OF SOLAR CELL (PHOTO CELL)

It's represented by FIG. (7/11-A),(7/11-B), (7/11-C). FIG. (7/11-A)

It represent cylindrical movable shaft, two arms fixed inside it, and solar -cell at top

(10) represent movable shaft have conical shape.

(14E,14F) represent the two arms of the movable shaft.

(15K,15P) are two connection terminals between the two terminal of the solar-cell (27) and the malt meter cross (17N,17Y) to points (7,8),it's clear at FIG. (7/11).

(20) long tidal opening for connection between the terminal of solar-cell (27A,27B) and the points (15K,15P).

(26) cylinder have screw inside for fixed the solar-cell

(27) solar -cell fixed at cylinder movable shaft by fixed it inside small cylinder have screw at out side to fixed it at shaft (26), I can make the top of the small cylinder as shape of hexagonal but smaller than the diameter of the small cylinder to can fixed easy inside the shaft.

(27A,27B) the two terminal of the solar-cell.

FIG. (7/11-B)

It represented by two cylinder (long cylinder, short cylinder),and source of light. The long cylinder for fixed the movable shaft and short cylinder for fixed the source of light.

a- long cylinder

(18P,18K) are longitudinal opening at long cylinder to can move the arms of the movable shaft with it.

(22Y,22M,22L) are ball Bering or small cylinder

(22Y)is smaller than the other ball Bering to prevent the movable shaft from falling

(22Z,38N) out side screw at the top of long cylinder to fixed the small cylinder.

(24) cylinder contain the ball Bering.

(33) top of cylinder which contain ball Bering.

b-small cylinder

(28) hexagonal to fixed small cylinder at the top of long cylinder.

(32T) end of the inside screw cylinder which the source of light move up and dawn through it

(32Y)extend of the inside cylinder out side cylinder (40).

(38F,15F)screw inside hexagonal.

(38L)top of the small cylinder

(42) top of the inside screw cylinder.

c-source of

(34) source of light.

(36) screw out the cylinder (45).

(44)longitudinal opening for path two wires to source of light.

(45)cylinder can move it up or dawn throw cylinder (42).

(46) hexagonal nut to control the moving of cylinder (45).

(47) end of tube (44) can connected with the tube (48)

FIG. (7/11-C)

It represent FIG. (7/11-A) and (7/11-B) after fixed them together. FIG. (8/11)

a-It represent FIG. (7/11-C) after fixed it in frame (19)as shape of (square wave of electric pour).

b-I fixed the two connection lines (17N) to point (7) and (17Y) to point (8).

c- (48) tube to path two wires from the source as battery (50) to the lamp(34) cross (47).

d- the up terminal of point (7), (8) are connected to the two terminal of malt meter and the dawn terminal to the two terminal of the photo-cell.

FIG.(9/11)

It represented by FIG. (9/11-A),(9/11-B).

FIG. (9/11-A) represent the movable shaft at lower level.

FIG. (9/11-B) represent the movable shaft at higher level.

I can fixed the device by use four screw (one screw at every corner and connected the malt meter out side the device or use frame like figure (13S) but have the size of figure (8/11) with fixed the malt meter

FIG.(10/11)

It represent by FIG. (10/11-A),(10/11-B),(10/11-C). FIG. (10/11-A)

It represent long cross section of movable shaft at.FIG. (1/11-C). FIG. (1O/11-B)

It represent long cross section at column at FIG. (2/11-B). FIG. (10/11-C)

it represent long cross section of movable shaft at FIG. (7/11-A). FIG.(11/11)

It's another design of caliper.

In this design I changed ideal caliper to digital caliper

It represented by FIG. (11/11-A),FIG. (11/11-B),FIG. (11/11-C),FIG. (1/11-D), FIG. (1/11-E). FIG. (11/11-A)

It represent ideal caliper

(8-A),(8-B) are two terminal for measure out side diameter

(8-C),(8-D) are two terminal for measure inside diameter

(19) movable part

(21) dial for reading

(23) fixed part

(27) part have tooth

(29) scale

FIG. (11/11-B)

It represent fixed part the movable shaft move inside it.

I fixed the variable resistance at FIG. (11/11-C) at this frame (fixed part). The arm which change the variable resistance is fixed at the moving shaft (8-G),(8-F) terminal of the fixed part.

(10) arm is used for change the variable resistance, when fixed the variable resistance in the movable part

(11-A),(11-B) are two hole the move movable shaft move inside it

(12) frame to fixed the variable resistance.

(14) part of the frame to fixed the connection point (1), and (2) and connected it to the terminal of the malt meter.

(17) long tidal opening which the back of movable shaft path inside it

(18) wheel tooth.

FIG. (11/11-C)

It represent the variable resistance, it's terminal (17) which connected to point(1),and (19) which connected to point (1)

FIG. (11/11-D)

It represent the caliper after fixed the movable shaft and the arm of the variable resistance inside the movable shaft.

I can fixed the variable resistance inside the frame (16).

FIG. (11/11-E)

It represent the electric circuit of the variable resistance and it's terminal(l),and (2) which connected to the two terminal of the malt meter.

### SUMMARY RAMIFICATION AND SCOPE

The idea of the apparatus is

How I can used the relation between the change of variable resistance and distance?. if R=PL/a and P/a is constant Or R=constant multiplied by L Or by other way R proportional with (L) where R is the variable resistance L is the length a is the cross section The idea is used at three apparatus

1- measure the length by using the relation between the change of the variable resistance and length as digital micrometer head.

2-mesure the length by using the relation between change of the resistance of solar cell and strength of light (or distance of light)

3- measure the inside, out side diameter and thickness by using the relation between the relation between change of variable resistance and length as caliper.

If I have variable resistance 1 Mohm and it's length 10 millimeter it mean that: Chang at distance 10 millimeter=change of resistance 1 Mohm And if R=constant multiplied by L

1 ohm=0,00001 millimeter

0,001 ohm=0,0000001 millimeter

### DETAIL DESCRIPTION OF THE APPARATUS

1-I can read 0,001 ohm and then can read 0,0000001 millimeter.

2- I can connected the malt meter with computer, and read distance at computer.

3- the apparatus is develop with develop of the computer and malt meter.

4- the apparatus is used for measure samples which move up and dawn continuously.

5- the apparatus is used as dial indicators for measure change of length by digital FIG. (5)

6- the apparatus is used as digital micrometer head.

7- I can find the velocity of increase or decrease of length of any samples by find the relation between length and time.

8- the apparatus is used as digital caliper.

9- the apparatus is used to measure the effect of pressure of samples of dust with length at test of land before start high building construction.

10- the apparatus is used for measure the sinking of pillars at cause of cracking at horizontal and vertical beams.

11-the apparatus is cheaper than any one.

12 the apparatus have (LCD resolution) 0,0000001.

13-I can have new reading if samples increased or decreased.

### OPERATION MAIN EMBODIMENT

I DESCRIBE NOW HOW THE THREE APPARATUS ARE WORK

1- DIGITAL MICROMETER HEAD (BY USING VARIABLE RESISTANCE)

FIG.(4/11-A) when the movable shaft (10) is moves the two arms (18-H), (18-L) are move and change the variable resistance (15-E),(15-F) by the arms (17-H),(17-L) which are fixed at the two arms of movable shaft.

If R=constant multiplied by distance(X) and

If constant=1 then R=X

If I adjusted the distance X=30 millimeter at resistance 3 Mohm in this case when reading is 3 Mohm the distance is 30 millimeter or reading 1 Mohm means 10 millimeter By other way 10 millimeter=1 Mohm 1 millimeter=100000 ohm

Or 0,00001 millimeter=1 ohm

0,0000001 millimeter=0,001 ohm

If constant not=1

then R=factor multiplied by (X) but R=PL/a and P/a=constant at the same temperature

1-first case when sample decrease from up to dawn.

a-I used resistance (15-E) when sample decrease or move from up to dawn

b -the change of reading at resistance (15-E), it's terminals (19X,19Y) can read it at point (1) and point (2).

c-terminal (19Y) connected to point(1) sharing point by printed cupper wire and to one terminal of the malt meter.

d- terminal (19X) connected to point(2) by printed cupper wire to the indictor (38) of the malt meter it's clear at FIG. (3/11-A),(3/11-B).

e-in this case zero position at point (19X).

2-second case when sample move from dawn to up.

a- in this case I used the variable resistance (15-F).

b- it's terminal (19E) is connected to point (1) the sharing point which connected to one terminal of malt meter, and terminal (19F) to point (3) by printed cupper to the indictor (38) of the malt meter.

c- the indictor of the malt meter is connected to one terminal.

d-it can changed between points (2,3,4,5) by using variable switch.

e-the other terminal connected to point (1).

3- the two terminal of the malt meter connected to the sharing point (1) and the other point to the indictor (38), it is clear at FIG. (3/11-B).

4- I used cylinder (37) the small diameter of the movable shaft at it's top enter inside it and the spring wire posh it down it's clear at FIG. (1/11-D)

5- I made small diameter of the movable shaft under the two arms to prevent it from fall and used small diameters of ball Bering (12-E) than the other (12-F), (12-G), it's clear at FIG. (1/11-D).

7- cylinder (37) can moving it up and dawn and fixed it inside the cover (32) for control of the spring wire.

8-after connected the apparatus with malt meter, I connected it with computer.

2-HUNG DIGITAL MICROMETER HEAD (AS DIAL INDICATORS) BY USING VARIABLE RESISTANCE FIG (5/11-A)

1- I used the same idea but:

a -I hung it as dial indicator by using Magnetic Base indictor holder by fixed it by using four screw at the halls (26E,26F,26G, 26H), and fixed it at frame.

b- I used two level of water (20-A),(20-B) to keep the apparatus vertical.

c-in this design the movable shaft (010)are free moving.

d- I fixed the movable shaft at frame as (L) shape.

e- it represent the movable shaft at lower level.

FIG.(5/11-B)

a- It represent the movable shaft at top level. FIG.(5/11-C)

a- it represent the movable shaft with two arms are fixed inside by screw.

b- the movable shaft and arms made by iron steal.

c- (17H),(17L) are two arms to change the variable resistance (15-E), (15-F).

3-DIGITAL CALIPER (BY USING VARIABLE RESISTANCE)

It represented by FIG. (4/11-B).

a-In this case the column (23) not free for move

b-I used moving (34) head of the screw (27) to control for moving column manual.

c-the screw moving throw frame (32) at cylinder screw (26L) and inside column (23) at cylinder screw(26F) it's clear at FIG. (2).

d-I used two arms (18-M) I fixed at the end of it arm (17B) for change the variable. resistance (15-M), and at arm (18-L) I fixed arm (17A) of variable resistance (15-N).

When I move the head of the screw (34), the column move.

1-I move the head (34) to adjust the sample which I like to measure it.

If the screw (27) move X space, the space between the two terminal (8L),(8F) at right side equal X space.

2-the two arms of the column also move X space.

3- the two arms of the variable resistance are change the resistance and move X space.

4- X space is proportional with the two variable resistance.

5- If R=constant multiplied by X and if this constant=1 then

R=X

If I adjusted the distant X=30 millimeter at resistance 3 Mohm

At this case the reading of malt meter 3 Mohm means 30 millimeter distance

Or 1 Mohm=10 millimeter

100000 ohm=1 millimeter 1 or 1 ohm=0,00001

0,001 ohm=0,0000001

If the constant not=1 then

R=factor multiplied by X

4-ANOTHER DESIGN OF DIGITAL CALIPER BY USING VARIABLE RESISTANCE FIG.(11/11)

It represented by FIG. (11/11-A),FIG. (11/11-B), FIG. (11/11-C), FIG. (11/11-D), FIG. (11/11-E).

It is another design of digital caliper.

In this design I changed ideal caliper to digital caliper. FIG. (11/11-A)

It represent ideal caliber.

FIG. (11/11-D)

In this design I changed the fixed part (23) at FIG. (11/11-A) by the frame at FIG. (11/11-B). In this frame I fixed variable resistance FIG. (11/11-C), the arm of this resistance is fixed at the movable shaft (21).

When movable shaft move it change the resistance of the variable resistance. I used the same idea. If R=constant multiplied by X (distance) And if constant=1 I can say R resistance=same reading (distance).

5- DIGITAL MICROMETER HEAD BY USING (THE RELATION BETWEEN CHANGE OF RESISTANCE OF SOLAR CELL AND STRENGTH OF LIGHT OR DISTANCE OF LIGHT IT REPRESENTED BY FIG.(8/11)

a-FIG. (8/11) represent FIG. (7/11-C) after fixed the movable shaft (7/11-A)and fixed all at frame (19)

b-printed cupper connection are fixed on the frame (17N,17Y) which connected to the two points (7),(8), and those points are connected to the two terminal of malt meter.

c-the other terminal of (17N,17Y) are connected to the two points (15P,15K) at the two arms of the movable shaft by spiral wire.

d- points (15P,15K) are connected to the two terminal (27A,27B) of the solar-cell (27) it's clear at FIG. (7/11-A).

e-I used source of pour as battery (50) have switch or electrical source for lighting the lamp.

f-I used taupe of cupper for path two wires to the lamp or source of light.g-the frame has longitudinal opening (18P,18K) to allow the movable shaft move.

h-the wire of connection not drawing at the FIG. (8/11)

NOW I DESCRIBE HOW THE APPARATUS IS WORK

1- when the lamp (34) on the solar-cell (27) which fixed at the top of movable shaft is effected by light.

2-the solar cell resistance effect by strength of light or by distance of light.

3- the distance of light can change by moving cylinder (47).

4-stringth of light can change by used variable resistance connected with the lamb.

5-I used this two methods for chows suitable resistance of the solar to start.

After chows resistance as zero position and the movable shaft move up. The resistance of the solar-cell change, this change proportional with distance of light or strength of light.

The resistance of solar-cell increase when distance increase

If R is the resistance X is the distance then R=constant multiplied by X IF this constant=1 Then R=X

If I control of the relation between the distance of light and resistance of solar-cell as when the resistance of solar-cell=4 Mohm the distance=40 millimeter or 10 millimeter=1 Mohm and so

I read this change of resistance at the screen of the malt meter it means distance.

If constant=1

If constant not=1

R=factor multiplied by X.

### OTHER EMBODIMENT

At FIG. (4/11) I describe how I can fixed the two apparatus inside one box and the malt meter is connected out side.

1- briefer to use the arms of all shaft as cylinder but out side end rectangular

2- All shaft made from solid steel, and frame from aluminum or solid plastic

3- I used the back side of the apparatus for fixed it Another method for fixed of the apparatus

I fixed the apparatus digital micrometer head at FIG. (11/1-D)after fixed the variable resistance (15-E) and (15-F) at FIG. (12S)

1-In this method I fixed every apparatus alone with malt meter at frame and fixed this frame by four screw

2- I fixed the apparatus at FIG. (1/11-D) inside the left part the parts (25),(14E)at FIG. (1/11-D)inside (32B),(21) at FIG. (11S) contentious, the resistance (15-E) at right side and resistance (15-F)at left side, then fixed the frame inside FIG. (13 S)

3-I enter FIG. (11S)inside FIG. (13S)

4-(53A) enter(55A), and(53B) enter(55B)

5-screw (4A),(4B),(4C),(4D) enter holes (5A),(5B),(5C),(5D)to fixed the apparatus

### ELECTRICAL CONNECTION

The two terminal of the variable resistance (15-E) are connected to the indictor ohm(36)and other terminal to sharing point (30L) point (2) means change of reading of resistance (15-E) the two terminal of other resistance (15-F) also connected to the indictor ohm (38)and the other terminal to sharing point (301). point (3)means change of reading at resistance (15-F) at left side I fixed digital malt meter

(30M),(30N) are two terminal of malt meter

(36) screen

(38) indictor

As the digital micrometer head I fixed the digital caliper at FIG. (2/11-D) with malt meter at FIG. (15S), but I used variable resistance (15-N),(15-M) which connected to point(4),(5) and sharing point (30L)

at FIG. (13S) I fixed the frame at FIG. (2/11-D)at the channel (28) from dawn to up, then I fixed all the frame inside FIG. (15S) the edge (54A) inside channel (55A)and edge (54B) inside (55B)

I used screw (4A,4B,4C,4D) inside holes (9A.9B,9C,9D)for fixed (14S) inside (15S)

(2) base for the apparatus at FIG. (14S),FIG. (12S)

(3H,3G,3M,3N)for fixed the cover

(39)empty space for fixed FIG. (11S),FIG. (12S) inside it.

1. A new method of measure distance and diameter by digital as digital micrometer head and digital caliper, I used the relation between change of resistance and distance at potentiometer(longitude variable resistance),which the distance is proportional with distance, by using (malt meter) ohm meter connected with computer

2. This closure of claim 1 wherein said reading of resistance means distance multiplied by factor.

3. A movable shaft move up and dawn, it fixed to a three ball bearing or hallo cylinder the movable shaft have two arms control for change two longitude variable resistance at left and right of the movable shaft, one of this resistance for measure when moving up and other when moving dawn, this device for why I used two resistance.

4. The closure of claim 3 said the two ends of every resistance connected to digital ohm meter (malt meter) for reading the resistance by using variable switch to do(on and off) between the two variable resistance and ohm meter this ohm meter connected by computer.

5. The closure of claim 3 said movable shaft have small diameter about half end it's bottom conical shape, this device for why I used dawn ball bearing small, so this point is zero point and prevent the shaft to fall dawn, I used two design (one hung the other fixed)

6. The closure of claim 3 said at digital caliper the dawn end of the shaft at caliper as the same of end of ideal caliper, I changed the ideal caliper to digital by using resistance changed by moving the movable part (another design).

7. Another new method by using the relation between change of resistance of photo electric-cell and distance of light or density of light about it, which proportional to each other, so the reading of resistance means (distance multiplied by factor).

8. The closure of claim 7 said movable shaft in this method have photoelectric cell at the top and source of light front it can move up and dawn throw screw cylinder, the two arms have hallo for path the two terminal of the photo cell which slip on two printed copper and connected to digital malt meter (ohm meter)which connected to computer.

9. The closure of claim 7 said about half of dawn diameter is smaller than the half top and I used three ball bearing the dawn is smaller also to prevent the shaft to fall.
